(19) United States
(12) Patent Application Publication
(10) Pub. No.: US 2005/0075265 A1
(43) Pub. Date: Apr. 7, 2005

(54) Two-phase compositions and uses thereof

(75) Inventors: Armelle De Salvert, Paris (FR); Arnaud Bonafos, Paris (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: L'OREAL, Paris (FR)

(21) Appl. No.: 10/921,990

(22) Filed: Aug. 20, 2004

Related U.S. Application Data
(60) Provisional application No. 60/507,935, filed on Oct. 3, 2003.

(30) Foreign Application Priority Data
Sep. 12, 2003 (FR) 0310748

(51) Int. Cl. C11D 17/00

(52) U.S. Cl. 510/407

(57) ABSTRACT

A composition containing sodium bicarbonate, an aqueous phase, and a separate oily phase. The presence of sodium bicarbonate makes it possible to obtain good phase separation of the two phases after stirring, and to avoid the formation of foam in the oily phase during stirring. Methods for removing makeup from, cleansing and/or caring for the skin, the lips and/or the eyes, or for haircare.

### REFERENCE TO PRIOR APPLICATIONS

This application claims priority to U.S. provisional application 60/507,935 filed Oct. 3, 2003, and to French patent application 0310748 filed Sep. 12, 2003, both incorporated herein by reference.

### FIELD OF THE INVENTION

The present invention relates to a composition having two separate phases, an aqueous phase and an oily phase, which is readily emulsified by shaking and readily undergoes phase separation after stopping the shaking. The composition is preferably suitable for topical application. The present invention also relates to the use of the composition, for example in cosmetics or dermatology, and especially for removing makeup from, cleansing and/or caring for the skin, the lips and/or the eyes, and/or for haircare.

Additional advantages and other features of the present invention will be set forth in part in the description that follows and in part will become apparent to those having ordinary skill in the art upon examination of the following or may be learned from the practice of the present invention. The advantages of the present invention may be realized and obtained as particularly pointed out in the appended claims. As will be realized, the present invention is capable of other and different embodiments, and its several details are capable of modifications in various obvious respects, all without departing from the present invention. The description is to be regarded as illustrative in nature, and not as restrictive.

### BACKGROUND OF THE INVENTION

Compositions of the type described herein and having two separate phases, especially an aqueous phase and a separate oily phase, which are not emulsified in each other at rest, are generally referred to as “two-phase ” (or “two phase”) compositions. They differ from emulsions by the fact that, at rest, the two phases are separate instead of being emulsified in each other. The use of these two-phase compositions requires prior shaking in order to form an emulsion, this emulsion needing to be of sufficient quality and stability to allow a uniform application of the two phases onto the skin or keratin material onto which it is applied. At rest, the phases must separate rapidly and regain their initial state, this phenomenon being known more commonly as “phase separation”.

Two-phase compositions have already been described, for example in documents EP-A-370 856 and EP-A-603 080, especially for removing makeup from the eyes.

Rapid phase separation (or demixing) of the two phases after they have been used is one of the desired qualities of two-phase compositions. Specifically, it is desirable to achieve rapid phase separation for various reasons, especially because users perceive poor separation of the two phases as being unattractive. Document EP-A-603 080 describes the use of alkyldimethylbenzylammonium and especially benzalkonium chloride as a phase-separating agent, to obtain this rapid phase separation. However, it is sought to diversify the type of molecule used as phase-separating agent in order to have available more varied compositions. However, it has proven to be difficult to find phase-separating agents. that can give good phase separation without resulting in the formation of foam in the oily phase of the two-phase system during shaking. This formation of foam is unacceptable to users.

There is thus still a need for a two-phase composition with two separate immiscible phases, which, after shaking and transient extemporaneous formation of the emulsion, undergoes rapid phase separation into two phases, without the formation of foam.

### DETAILED DESCRIPTION OF THE PREFERRED EMBODIMENTS

The inventors have found, surprisingly, that the use of sodium bicarbonate makes it possible to obtain a two-phase composition that has the desired qualities, i.e. which separates rapidly into two clear phases after use, without there being any appreciable formation of foam in the oily phase during shaking. Thus, the presence of sodium bicarbonate makes it possible to obtain good phase separation of the two phases after shaking, while at the same time avoiding the formation of foam in the oily phase during shaking. In addition, this compound has the advantage of being very well tolerated, which includes its application to the eyes, which are particularly sensitive to compounds liable to be of aggressive nature. Sodium bicarbonate has no aggressive nature and may thus be used advantageously in cosmetics and in particular in a makeup-removing composition for the eyes.

More particularly, one subject of the invention is a two-phase composition comprising an aqueous phase and an oily phase, in a weight ratio ranging from 25/75 to 90/10 (i.e., the aqueous phase generally represents from 25% to 90% by weight of the total weight of the composition), characterized in that it contains sodium bicarbonate. In this regard the invention includes the two-phase composition in both shaken and at-rest forms. It should be noted that in both the shaken and at-rest forms the oily phase can be described as being a separate phase.

Since the composition according to the invention is preferably intended for topical application, it preferably constitutes a physiologically acceptable medium, i.e. a medium that is compatible with the skin, mucous membranes, the hair and the scalp, etc.

The composition according to the invention thus comprises at least one aqueous phase and at least one separate oily phase. These two phases are separate, i.e. they are visible one above the other at rest, and remain separate but intermixed after shaking in order to form an emulsion. In addition, they are preferably transparent at rest. The two phases may independently be coloured or colourless.

The term “transparent” as used herein means that the composition has a turbidity of less than or equal to 300 NTU. The transparency of a composition can be measured by its turbidity, and the NTUs (Nephelometric Turbidity Units) are the units for measuring the turbidity of a composition. The turbidity measurement may be performed, for example, using a 2100P model turbidimeter from the Hach Company, the tubes used for the measurement being referenced AR397A cat 24347-06. The measurements are performed at room temperature (20° C. to 25° C.). The composition of the invention generally has a turbidity ranging from 2 to 300 NTU and preferably from 5 to 200 NTU, including 10, 25, 50, 100, and 150 NTU.

Sodium bicarbonate is the sodium salt NaHCO₃, and it is all the more surprising that it allows good phase separation and that other salts, and especially other sodium salts, cannot achieve the desired aim, as will be shown later by the comparative examples. The amount of sodium bicarbonate present in the invention compositions is not particularly limited, and generally may range, for example, from 0.005% to 5% by weight, preferably from 0.01% to 5% by weight, better still from 0.05% to 3% by weight and even better still from 0.1% to 2% by weight, including 0.2, 0.4, 0.6, 0.8. 1, 1.2, 1.4, 1.6, and 1.8% by weight, relative to the total weight of the composition.

In addition to bicarbonate, it is possible to add another salt(s), for instance sodium chloride, which has no effect on the phase separation, but which is used as adjuvant in a makeup-removing composition for the eyes in order for the composition to have an osmotic pressure close to that of tears. The amount of salt(s) other than bicarbonate may range, for example, from 0 to 5% by weight, preferably from 0.001% to 3% by weight and better still from 0.005% to 2% by weight relative to the total weight of the composition.

The weight ratio between the aqueous phase and the oily phase in the invention compositions preferably ranges from 25/75 to 90/10, preferably from 30/70 to 70/30 and better still from 40/60 to 60/40. Thus, the aqueous phase generally represents from 25% to 90% by weight, preferably from 30% to 70% by weight and better still from 40% to 60% by weight, including 45, 50, and 55 % by weight, relative to the total weight of the composition.

The aqueous phase of the composition according to the invention comprises water and any water-soluble or water-dispersible additive. The water used is not limited and may be sterile demineralized water and/or a floral water such as rosewater, cornflower water, camomile water or lime water, and/or a natural mineral water or spring water, for instance: eau de Vittel, waters from the Vichy basin, eau d'Uriage, eau de la Roche Posay, eau de la Bourboule, eau d'Enghien-les-Bains, eau de Saint Gervais-les-Bains, eau de Néris-les-Bains, eau d'Allevar-les-Bains, eau de Digne, eau de Maizières, eau de Neyrac-les-Bains, eau de Lons-le-Saunier, les Eaux Bonnes, eau de Rochefort, eau de Saint Christau, eau des Fumades, eau de Tercis-les-bains and eau d'Avene. The aqueous phase may also comprise reconstituted spring water, i.e. water containing trace elements such as zinc, copper, magnesium, etc., which reconstitutes the characteristics of a spring water.

Water-soluble additives that may especially be mentioned include polyols such as glycerol and glycols such as hexylene glycol, polyethylene glycols and polypropylene glycol. The polyols may be present in an amount ranging from 0 to 5% by weight, preferably from 0.01% to 5%, better still from 0.05% to 3% by weight and even better still from 0.1% to 3% by weight relative to the total weight of the composition. According to one preferred embodiment of the invention, the composition contains at least one polyol, preferably glycerol or hexylene glycol, or mixtures thereof.

Water-soluble additives that may also be mentioned include C₂-C₈ primary alcohols, and especially ethanol. According to one particular embodiment of the invention, the composition is preferably virtually free of ethanol. The expression “virtually free of ethanol” means herein a composition containing less than 2% by weight and preferably less than 1% by weight of ethanol relative to the total weight of the composition.

The oily phase of the composition of the invention generally represents from 10% to 75%, preferably from 30% to 70% by weight and better still from 40% to 60% by weight, including 45, 50, and 55% by weight, relative to the total weight of the composition.

The oily phase of the composition according to the invention may contain one or more oils, these oils each possibly being mineral, plant or synthetic oils or alternatively silicone oils. They may also comprise liposoluble or lipodispersible additives.

According to one preferred embodiment of the invention, the oily phase comprises one or more oils chosen from hydrocarbon-based oils of mineral or synthetic origin and silicone oils. More particularly, the oily phase advantageously contains one or more volatile oils chosen from volatile hydrocarbon-based oils of mineral or synthetic origin and volatile silicone oils.

The term “hydrocarbon-based oil” means an oil formed essentially from, or even consisting of, carbon and hydrogen atoms, and possibly oxygen and nitrogen atoms, and containing no silicon or fluorine atoms; it may contain ester, ether, amine or amide groups.

Volatile hydrocarbon-based oils of mineral or synthetic origin that may be mentioned include C₈-C₁₆ isoalkanes (also known as isoparaffins), such as isododecane, isodecane and isohexadecane, for instance the isoalkanes sold under the trade name Isopar by the company Exxon Chemical or the oils sold under the trade name Permethyl by the company Presperse; and mixtures thereof.

Non-volatile hydrocarbon-based oils of mineral or synthetic origin that may be mentioned include liquid petroleum jelly and hydrogenated polyisobutene such as Parleam® oil; and mixtures thereof.

The term “silicone oil” means an oil containing at least one silicon atom, and especially containing Si-O groups. The silicone oil may be chosen from non-volatile silicone oils and volatile silicone oils, and mixtures thereof.

The volatile silicone oils that may be used in the invention include those chosen from silicone oils with a flashpoint ranging from 40° C. to 102° C., preferably with a flashpoint of greater than 55° C. and less than or equal to 95° C., and preferentially ranging from 65° C. to 95° C. Volatile silicone oils that may be mentioned include linear or cyclic silicone oils containing from 2 to 7 silicon atoms, these silicones optionally comprising alkyl or alkoxy groups containing from 1 to 10 carbon atoms. Examples of volatile silicone oils that may especially be mentioned include cyclopolydimethylsiloxanes (INCI name: cyclomethicone), such as cyclopentasiloxane, cyclohexasiloxane, octamethylcyclotetrasiloxane, decamethylcyclopentasiloxane and dodecamethylcyclohexasiloxane; linear silicones such as heptamethylhexyltrisiloxane, heptamethyloctyltrisiloxane, hexamethyldisiloxane, octamethyltrisiloxane, decamethyltetrasiloxane and dodecamethylpentasiloxane; and mixtures thereof.

The non-volatile silicone oils that may be used in the invention include those chosen from polydimethylsiloxanes (PDMSs) and phenylated polymethylsiloxanes such as phenyl trimethicones, phenyl dimethicones, phenyltrimethylsiloxydiphenylsiloxanes, diphenyl dimethicones, diphenylmethyldiphenyltrisiloxanes, 2-phenylethyltrimethyl siloxysilicates and polymethylphenylsiloxanes; polysiloxanes modified with fatty acids, fatty alcohols or polyoxyalkylenes, and mixtures thereof.

Preferably, the oily phase contains at least one volatile oil and especially at least one isoalkane, preferably a mixture of isododecane and isohexadecane. According to another preferred embodiment of the invention, the oily phase contains at least one isoalkane and at least one volatile silicone oil, and preferably a mixture of one or more isoalkanes chosen from isododecane and isohexadecane, and one or more volatile silicone oils.

The oily phase may contain one or more other volatile or non-volatile oils, chosen for example from hydrocarbon-based oils of animal or plant origin, synthetic esters and ethers, fatty alcohols and fluoro oils, and mixtures thereof.

The term “fluoro oil” means an oil containing at least one fluorine atom.

As oils that may be used in the composition of the invention, examples that may be mentioned include:

hydrocarbon-based oils of animal origin, such as perhydrosqualene;

hydrocarbon-based oils of plant origin, such as liquid triglycerides of fatty acids containing from 4 to 10 carbon atoms, for instance heptanoic or octanoic acid triglyceride, or alternatively, for example, sunflower oil, maize oil, soybean oil, marrow oil, grapeseed oil, sesame seed oil, hazelnut oil, apricot kernel oil, macadamia oil, arara oil, coriander oil, castor oil, avocado oil, caprylic/capric acid triglycerides, for instance those sold by the company Stearineries Dubois or those sold under the names Miglyol 810, 812 and 818 by the company Dynamit Nobel, jojoba oil and shea butter oil;

synthetic esters and ethers, especially of fatty acids, for instance the oils of formulae R¹COOR² and R¹OR² in which R¹ represents a fatty acid residue containing from 8 to 29 carbon atoms and R² represents a branched or unbranched hydrocarbon-based chain containing from 3 to 30 carbon atoms, for instance Purcellin oil, isononyl isononanoate, isopropyl myristate, isopropyl palmitate, 2-ethylhexyl palmitate, 2-octyldodecyl stearate, 2-octyldodecyl erucate or isostearyl isostearate; hydroxylated esters, for instance isostearyl lactate, octyl hydroxystearate, octyldodecyl hydroxystearate, diisostearyl malate, triisocetyl citrate, and fatty alcohol heptanoates, octanoates or decanoates; polyol esters, for instance propylene glycol dioctanoate, neopentyl glycol diheptanoate and diethylene glycol diisononanoate; and pentaerythritol esters, for instance pentaerythrityl tetraisostearate.

The oils may optionally consist solely of volatile oils.

The two-phase composition according to the invention may optionally comprise one or more surfactants in either or both of the phases, especially when it is used as a makeup-removing or cleansing composition, since the presence of a surfactant makes it possible both to obtain good makeup removal of makeup compositions and especially of mascaras, and also to have no greasy sensation during the makeup removal. However, the composition of the invention may also be free of surfactant, and, if it contains any, the amount of surfactant should be such that the composition remains, at rest, in the form of two separate phases rather than in the form of an emulsion.

When the composition of the invention contains surfactant, the surfactant may be of the anionic, nonionic or amphoteric type, including mixtures thereof, but is preferably of the nonionic type, and it is preferably present in the aqueous phase of the composition.

The amount of surfactant(s) as active material is not limited and may range, for example, from 0.001% to 1% by weight, preferably from 0.002% to 0.5% by weight and better still from 0.01% to 0.3% by weight relative to the total weight of the composition.

Among the nonionic surfactants, those that are particularly preferred are:

polyoxyethylenated fatty esters of sorbitol, such as the product sold under the name Tween 20 by the company ICI;

condensates of ethylene oxide and of propylene oxide, such as those sold under the name Synperonic PE by the company ICI and in particular those referenced L 31, L 64, F 38, F 88, L 92, P 103, F 108 and F 127;

alkylpolyglycosides such as those of general formula (I) below:
R-O-(G)ₓ (I)
in which R represents a linear or branched, saturated or unsaturated alkyl radical containing from 6 to 30 carbon atoms, G represents a reduced sugar containing from 5 to 6 carbon atoms, and x denotes a value ranging from 1 to 15;

and mixtures thereof.

According to one preferred embodiment of the invention, when the composition contains a surfactant, it contains at least one nonionic surfactant and preferably at least one alkylpolyglycoside.

Alkylpolyglycosides that are preferably used according to the present invention are compounds of formula (I) in which R more particularly denotes an alkyl radical containing from 6 to 30 carbon atoms and preferably from 8 to 16 carbon atoms, G denotes glucose, fructose or galactose, x is a value ranging from 1 to 4 and more particularly from 1 to 3. According to one preferred embodiment of the invention, the alkylpolyglycoside used in the composition of the invention is an alkylpolyglucoside, that is to say a compound of formula (I) in which G denotes glucose, with x preferably having a value ranging from 1.2 to 3.

Examples of alkylpolyglucosides that may be mentioned include decylglucoside (alkyl-C9/C11-polyglucoside (1.4)), for instance the product sold under the name Mydol 10 by the company Kao Chemicals, the product sold under the name Plantaren 2000 UP and Plantacare 2000 UP by the company Henkel, and the product sold under the name Oramix NS 10 by the company SEPPIC; caprylyl/capryl glucoside, for instance the product sold under the name Oramix CG 110 by the company SEPPIC or under the name Lutensol GD 70 by the company BASF; laurylglucoside, for instance the products sold under the names Plantaren 1200 N and Plantacare 1200 by the company Henkel; and cocoglucoside, for instance the product sold under the name Plantacare 818/UP by the company Henkel, and mixtures thereof.

The composition according to the invention may also contain cosmetic adjuvants and/or additives, which can be in one or the other phase, or both, depending on their hydrophilic or lipophilic nature, for instance fragrances, preserving agents and bactericides, dyes, softeners, buffers, humectants, UV-screening agents (or sunscreens), electrolytes such as sodium chloride as indicated above, or a pH regulator (for example citric acid or sodium hydroxide), and mixtures thereof.

Preserving agents that may be used include any preserving agent usually used in the fields under consideration, for instance parabens, chlorhexidine gluconate and polyhexamethylene biguanide hydrochloride (CTFA name: polyaminopropyl biguanide). According to one preferred embodiment of the invention, the composition contains polyhexamethylene biguanide hydrochloride, alone or as a mixture with other preserving agents.

Examples of bactericides that may be used include a glyceryl mono(C₃-C₉)alkyl or mono(C₃-C₉)alkenyl ether, the manufacture of which is described in the literature, in particular in E. Baer, H.O.L. Fischer—J. Biol. Chem. 140-397-1941. Among these glyceryl mono (C₃-C₉) alkyl or mono (C₃-C₉) alkenyl ethers, 3-[(2-ethylhexyl)oxy]-1,2-propanediol, 3-[(heptyl)oxy]-1,2-propanediol, 3-[(octyl)oxy]-1,2-propanediol and 3-[(allyl)oxy]-1,2-propanediol are preferably used. A glyceryl mono(C₃-C₉)alkyl ether that is more particularly preferred according to the present invention is 3-[(2-ethylhexyl)oxy]-1,2-propanediol, sold by the company Schulke & Mayr GmbH under the trade name Sensiva SC 50 (INCI name: ethylhexylglycerin).

Among the softeners that may be mentioned in particular are allantoin, bisabolol, planktons, and certain plant extracts, for instance extracts of rose and extracts of melilot.

The active agent(s) that may be present depend(s) on the final aim of the composition. As active agents that may be used in the composition of the invention, especially when it concerns a skincare composition, examples that may be mentioned include enzymes (for example lactoperoxidase, lipase, protease, phospholipase and cellulases); flavonoids, such as isoflavones; moisturizers such as protein hydrolysates; sodium hyaluronate; anti-inflammatory agents; procyannidol oligomers; vitamins, for instance vitamin A (retinol), vitamin E (tocopherol), vitamin C (ascorbic acid), vitamin B5 (panthenol), vitamin B3 (niacinamide), derivatives of these vitamins (especially esters) and mixtures thereof; urea; caffeine; depigmenting agents such as kojic acid, hydroquinone and caffeic acid; salicylic acid and its derivatives; α-hydroxy acids such as lactic acid and glycolic acid and derivatives thereof; retinoids such as carotenoids and vitamin A derivatives; hydrocortisone; melatonin; algal extracts, fungal extracts, plant extracts, yeast extracts or bacterial extracts; steroids; antibacterial active agents, for instance 2,4,4′-trichloro-2′-hydroxydiphenyl ether (or triclosan), 3,4,4′-trichlorocarbanilide (or triclocarban) and the acids indicated above, and especially salicylic acid and its derivatives; tensioning agents; ceramides; essential oils; and mixtures thereof; and any active agent that is suitable for the final aim of the composition.

The UV-screening agents may be present in the composition according to the invention, especially when it is intended for antisun care. These screening agents may especially be organic screening agents, and may be present in an active-material amount ranging from 0.01% to 20% by weight of active material, preferably from 0.1% to 15% by weight and better still 0.2% to 10% by weight relative to the total weight of the composition.

As examples of UV-A-active and/or UV-B-active organic screening agents that may be added to the composition of the invention, examples that may be mentioned include derivatives containing a sulfonic function, such as sulfone-containing or sulfonate-containing derivatives of benzylidenecamphor, of benzophenone or of phenylbenzimidazole, more particularly benzylidenecamphor derivatives, for instance benzene-1,4-bis(3-methylidenecamphor-10-sulfonic acid) (INCI name: Terephthalylidenedicamphor-sulfonic acid) manufactured under the name “Mexoryl SX” by the company Chimex, 3-benzylidenecamphor-4′-sulfonic acid (INCI name: Benzylidenecamphorsulfonic acid), manufactured under the name “Mexoryl SL” by the company Chimex, 2-[4-(camphormethylidene)phenyl]benzimidazole-5-sulfonic acid and phenylbenzimidazolesulfonic acid (INCI name: Phenylbenzimidazolesulfonic acid), sold under the name Eusolex 232 by the company Merck; paraaminobenzoic acid derivatives; salicylic derivatives such as ethylhexyl salicylate sold under the trade name Neo Heliopan OS by Haarmann & Reimer; dibenzoylmethane derivatives such as butylmethoxydibenzoylmethane sold especially under the trade name Parsol 1789 by Hoffmann La Roche; cinnamic derivatives such as ethylhexyl methoxycinnamate sold especially under the trade name Parsol MCX by Hoffmann La Roche; β,β′-diphenylacrylate derivatives such as octocrylene (2-ethylhexyl α-cyano-β,β-diphenylacrylate) sold under the trade name Uvinul N539 by the company BASF; benzophenone derivatives such as Benzophenone-1 sold under the trade name Uvinul 400 by BASF, Benzophenone-2 sold under the trade name Uvinul D50 by BASF, Benzophenone-3 or Oxybenzone, sold under the trade name Uvinul M40 by BASF, Benzophenone-4 sold under the trade name Uvinul MS40 by BASF; benzylidenecamphor derivatives such as 4-methylbenzylidenecamphor sold under the trade name Eusolex 6300 by Merck; phenylbenzimidazole derivatives such as Benzimidazilate sold under the trade name Neo Heliopan AP by Haarmann & Reimer; triazine derivatives such as Anisotriazine sold under the trade name Tinosorb S by Ciba Geigy and ethylhexyltriazone sold especially under the trade name Uvinul T150 by BASF; phenylbenzotriazole derivatives such as Drometrizole Trisiloxane sold under the trade name Silatrizole by Rhodia Chimie; anthranilic derivatives such as menthyl anthranilate sold under the trade name Neo Heliopan MA by Haarmann & Reimer; imidazoline derivatives; benzalmalonate derivatives; and mixtures thereof.

The compositions described above may be packaged, in a known manner, in a single-compartment bottle. The user can then shake the bottle before applying some of the contents thereof, for example to a pad of cotton wool. Provision may also be made for the two phases of the composition to be introduced into two independent compartments of the same bottle, a system being provided to mix them together at the time of distribution. Such devices are described, for example, in documents EP-A-497 256 and FR-A-2 697 233.

The composition according to the invention may be used for any topical application; especially, it may constitute a cosmetic or dermatological composition.

It may be used in particular to care for, cleanse and/or remove makeup from the skin, the lips and/or the eyes, and also as a haircare composition.

A subject of the invention is thus also the cosmetic use of a cosmetic composition as defined above, to care for, remove makeup from and/or cleanse the skin, the lips and/or the eyes, and/or for haircare.

A subject of the present invention is also a cosmetic process for removing makeup from, cleansing and/or caring for the skin, the lips and/or the eyes, characterized in that a cosmetic composition as defined above is applied to the skin, the lips and/or the eyes.

A subject of the present invention is also a cosmetic haircare process, characterized in that a cosmetic composition as defined above is applied to the hair.

According to one preferred embodiment of the invention, the composition constitutes a makeup-removing composition for the eyes.

The example below of compositions according to the invention is given for illustrative purposes and with no limiting nature. The amounts therein are given as percentages by weight, unless otherwise mentioned.

### EXAMPLE 1

### Makeup-Removing Composition

| Oily phase | |
|---|---|
| cyclopentasiloxane | 35% |
| isododecane | 7.5% |
| isohexadecane | 7.5% |
| dye | 0.05% |
| Aqueous phase | |
| glycerol | 1.5% |
| polyhexamethylene biguanide | 0.35% |
| hydrochloride | |
| sodium bicarbonate | 1% |
| demineralized water | 47.10% |

Procedure: The constituents of the oily phase, on the one hand, and those of the aqueous phase, on the other hand, were mixed together. The two phases were then shaken.

A composition was obtained, which, at rest, comprises an aqueous phase and a separate oily phase. When they were shaken, an emulsion was formed and no foam appeared. After stopping the shaking, the two phases rapidly separated.

### EXAMPLE 2

### Skincare Composition

| Oily phase | |
|---|---|
| cyclopentasiloxane | 30% |
| hydrogenated polyisobutene | 19.5% |
| apricot kernel oil | 0.5% |
| (Prunus armeniaca kernel oil) | |
| Aqueous phase | |
| glycerol | 1% |
| polyhexamethylene biguanide | 0.35% |
| hydrochloride | |
| sodium bicarbonate | 1% |
| demineralized water | 47.65% |

Procedure: The constituents of the oily phase, on the one hand, and those of the aqueous phase, on the other hand, were mixed together. The two phases were then shaken.

This composition may be used especially for skincare.

### COMPARATIVE EXAMPLE 1

### Makeup-Removing Composition

In Example 1, the sodium bicarbonate was replaced with sodium sulfate.

A composition comprising foam in the fatty phase was obtained.

### COMPARATIVE EXAMPLE 2

### Makeup-Removing Composition

In Example 1, the sodium bicarbonate was replaced with sodium lactate.

A composition comprising foam in the fatty phase was obtained.

The above written description of the invention provides a manner and process of making and using it such that any person skilled in this art is enabled to make and use the same, this enablement being provided in particular for the subject matter of the appended claims, which make up a part of the original description and including a two phase composition comprising an aqueous phase, a separate oily phase, and sodium bicarbonate, wherein said aqueous phase and separate oily phase are present in a weight ratio ranging from 25/75 to 90/10 aqueous phase/oily phase. Preferred embodiments of the invention similarly fully described and enabled include a composition for topical application, consisting of an aqueous phase and of a separate oily phase, in a weight ratio ranging from 25/75 to 90/10, characterized in that it contains sodium bicarbonate.

As used above, the phrases “selected from the group consisting of,” “chosen from,” and the like include mixtures of the specified materials.

All references, patents, applications, tests, standards, documents, publications, brochures, texts, articles, etc. mentioned herein are incorporated herein by reference. Where a numerical limit or range is stated, the endpoints are included. Also, all values and subranges within a numerical limit or range are specifically included as if explicitly written out.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein.

1. A two phase composition comprising an aqueous phase, a separate oily phase, and sodium bicarbonate, wherein said aqueous phase and said separate oily phase are present in a weight ratio of 25/75 to 90/10 aqueous phase/oily phase.

2. The two phase composition according to claim 1, wherein the amount of sodium bicarbonate is 0.005% to 5% by weight relative to the total weight of the composition.

3. The two phase composition according to claim 1, wherein the weight ratio between the aqueous phase and the oily phase is 30/70 to 70/30.

4. The two phase composition according to claim 1, wherein said oily phase comprises only volatile oils.

5. The two phase composition according to claim 1, wherein the oily phase comprises one or more oils selected from the group consisting of hydrocarbon-based oils of mineral or synthetic origin and silicone oils.

6. The two phase composition according to claim 5, wherein the oily phase comprises at least one volatile oil.

7. The two phase composition according to claim 6, wherein the oily phase comprises a mixture of one or more isoalkanes selected from the group consisting of isododecane and isohexadecane, and one or more volatile silicone oils.

8. The two phase composition according to claim 1, further comprising at least one non-ionic surfactant.

9. The two phase composition according to claim 1, further comprising at least one surfactant, wherein the at least one surfactant is present in an amount of 0.001% to 1% by weight relative to the total weight of the composition.

10. The two phase composition according to claim 1, wherein it is a cosmetic or dermatological composition.

11. The two phase composition according to claim 1, wherein said sodium bicarbonate is present in an amount of 0.4% to 1.8% by weight relative to the total weight of the composition, and
wherein said aqueous phase and separate oily phase are present in a weight ratio of 40/60 to 60/40 aqueous phase/oily phase.

12. The two phase composition according to claim 4, wherein said sodium bicarbonate is present in an amount of 0.4% to 1.8% by weight relative to the total weight of the composition, and
wherein said aqueous phase and separate oily phase are present in a weight ratio of 40/60 to 60/40 aqueous phase/oily phase.

13. The two phase composition according to claim 5, wherein said sodium bicarbonate is present in an amount of 0.4% to 1.8% by weight relative to the total weight of the composition, and
wherein said aqueous phase and separate oily phase are present in a weight ratio of 40/60 to 60/40 aqueous phase/oily phase.

14. The two phase composition according to claim 6, wherein said sodium bicarbonate is present in an amount of 0.4% to 1.8% by weight relative to the total weight of the composition, and
wherein said aqueous phase and separate oily phase are present in a weight ratio of 40/60 to 60/40 aqueous phase/oily phase.

15. The two phase composition according to claim 7, wherein said sodium bicarbonate is present in an amount of 0.4% to 1.8% by weight relative to the total weight of the composition, and
wherein said aqueous phase and separate oily phase are present in a weight ratio of 40/60 to 60/40 aqueous phase/oily phase.

16. The two phase composition according to claim 8, wherein said sodium bicarbonate is present in an amount of 0.4% to 1.8% by weight relative to the total weight of the composition, and
wherein said aqueous phase and separate oily phase are present in a weight ratio of 40/60 to 60/40 aqueous phase/oily phase.

17. The two phase composition according to claim 9, wherein said sodium bicarbonate is present in an amount of 0.4% to 1.8% by weight relative to the total weight of the composition, and
wherein said aqueous phase and separate oily phase are present in a weight ratio of 40/60 to 60/40 aqueous phase/oily phase.

18. A method for caring for, removing makeup from and/or cleansing the skin, the lips and/or the eyes, and/or for haircare, comprising applying to the the skin, the lips, the eyes, and/or the hair the composition of claim 1.

19. The method of claim 18, for caring for, removing makeup from and/or cleansing the skin, the lips and/or the eyes, comprising applying the composition of claim 1 to the skin, the lips and/or the eyes.

20. The method of claim 18, for haircare, comprising applying the composition of claim 1 to the hair.
